(19) United States
(12) Patent Application Publication
(10) Pub. No.: US 2026/0246091 A1
(43) Pub. Date: Aug. 20, 2026

(54) CERAMIC COATED SEPARATOR AND ADHESIVE

(71) Applicants: The Lubrizol Corporation, Wickliffe, OH (US); Nanyang Technology University, Singapore (SG)

(72) Inventors: Sun Yew Wong, Jurong (SG); Smita Brijmohan, Brecksville, OH (US); Ai Qin Thang, Jurong (SG); Ge Yao, Jurong (SG); Qingyu Yan, Singapore (SG)

(21) Appl. No.: 19/304,955

(22) Filed: Aug. 20, 2025

Related U.S. Application Data
(60) Provisional application No. 63/759,352, filed on Feb. 17, 2025.

(51) Int. Cl. H01M 50/449; H01M 10/0525; H01M 50/414; H01M 50/431; H01M 50/446

(52) U.S. Cl. CPC H01M 50/449; H01M 10/0525; H01M 50/414; H01M 50/431; H01M 50/446

(57) ABSTRACT

The disclosed technology relates to a ceramic coated separator for electrochemical cells, such as lithium-ion batteries, as well as to the ceramic coated separator incorporating an adhesive system.

### BACKGROUND OF THE INVENTION

The disclosed technology relates to electrochemical cells, such as lithium-ion batteries, with anodes and cathodes or ceramic coated separators, as well as to a ceramic coated separator, incorporating an adhesive system.

The demand for high energy density batteries is increasing. Lithium-ion batteries are one of the most promising battery types currently used.

Lithium-ion batteries are generally composed of an anode, made of a carbon material or a lithium-metal alloy, a cathode, made of a lithium-metal oxide, and an electrolyte in which a lithium salt is dissolved in an organic solvent. These batteries include a separator to allow the passage of lithium ions between the positive and the negative electrode during the charging and the discharging processes.

Safety of lithium-ion batteries is an important issue. The separator prevents the direct contact between the two electrodes, which would lead to an internal short circuit. Thus, the structure of such separators is considered to be crucial for the safety of lithium-ion batteries.

It is electronically insulating to physically separate cathode from anode, mitigating the risk of internal short circuiting. Separators are typically ultrathin and porous for Li⁺ to move through, shuttling between cathode and anode with minimal resistance during charging and discharging. Separators tend to shrink at elevated temperatures and are easily punctured by lithium dendrites when overcharged. A ceramic coated separator (CCS) can circumvent these shortfalls and even improve the electrochemical performance of a lithium-ion battery.

However, conventional manufacturing processes for a CCS induce high mechanical stress, causing serious delamination of the ceramic coating from the separator. This issue inherently jeopardizes the safety and lifespan of the battery.

Polymer binders are therefore essential for stable, everlasting, and high moisture repulsion CCSs. Binders should be mechanically flexible with good adhesive-ability and electrochemically stable.

Carboxymethyl cellulose (CMC), styrene butadiene rubber (SBR), polyacrylic acid (PAA) and polyacrylic latex (PAL) are common binders used for this application. Due to the inherent brittleness of CMC, it is typically used with SBR, which has been reported to affect battery cycling stability. Even though

PAL is known to provide some mechanical flexibility and exhibits good oxidation stability, the applicability is limited by its relatively poor dispersion efficiency, which hampers the handling process. Conversely, owing to the high concentration of carboxylic groups (—COOH) in PAA (higher than CMC), PAA is expected to provide high adhesion strength due to the hydrogen bonding formed between hydroxyl groups of PAA and oxygen functional groups formed on surface-treated polyolefin separator. However, PAA tends to bond amongst itself via (internal) hydrogen bonds, influencing the adhesion strength. Partially neutralized PAA (PPAA) can mitigate this issue as the dissociated carboxylates can stretch the polyacrylate chain due to the presence of electrostatic repulsion. In addition, dissociated carboxylates of PPAA can provide repulsive force to disperse a-alumina by masking Van der Waals attractive forces from surfaces of fine alumina particles, mitigating agglomeration issues.

Despite all these benefits, PPAA is brittle and hygroscopic in nature which can affect the mechanical robustness of a CCS and cause moisture to re-absorb during storage. This then requires pre-drying of CCS before assembling in the lithium-ion battery. Otherwise, the reabsorbed moisture in CCS can cause electrochemical failure in the battery. Wax is typically added to the ceramic slurry to increase hydrophobicity and thus enhances moisture repulsion. However, wax is less dense than water. Due to gravitational forces, the wax particles can undergo creaming which results in the separation of wax phase from the aqueous phase of the ceramic slurry. As such, it can lead to poor coating uniformity on the separator and affect the Li⁺ pathway across the CCS.

Thus, there is a need for an adhesive with good adhesive strength, improved durability and good hydrophobicity.

### SUMMARY OF THE INVENTION

In one embodiment, the disclosed technology, solves the problem of poor adhesion strength, cyclability and poor hydrophobicity of current binders for electrochemical cells, and specifically for ceramic coated separators by providing a dual polymer adhesive system.

The disclosed technology provides a method of improving electrochemical cell cycling. The method can include preparing a separator by coating a polymeric film with an adhesive composition as disclosed herein and then installing the separator and cycling the electrochemical cell. In an embodiment, the electrochemical cell can be a lithium-ion battery.

The adhesive composition can contain a combination of (a) a water based steric stabilizer polymer containing at least 60 wt. % polyether, and containing acid groups, and (b) a polycarboxylic acid (PCA) polymer, such as a polyacrylic acid (PAA) polymer. As used herein, the term polymer includes both homopolymers and copolymers.

In an embodiment, the water based steric stabilizer polymer can be the reaction product of (i) a copolymer, and (ii) a mono-nucleophile (amine or alcohol) terminated polyether derived primarily from ethylene oxide. The copolymer of (i) itself can be a copolymer of (1) maleic anhydride, itaconic anhydride, or a combination thereof, and (2) at least one non-acid containing monomer, such as styrene.

In an embodiment, the polyether of the mono-nucleophile terminated polyether of (ii) can include greater than 75 mol % of repeat units derived from ethylene oxide. From 30 to 60 mol % of the anhydride of (1) in copolymer (i) can be reacted with the mono-nucleophile terminated polyether of (ii).

The PCA polymer can include partially neutralized polycarboxylic acid (PPCA), such as partially neutralized polyacrylic acid (PPAA).

The adhesive composition can further include ceramic particles, such as a-alumina, generally having a Dv90 particle size of less than 1000 nm. The ceramic particles can be present between 50 to 99 wt. % of the adhesive composition.

### DETAILED DESCRIPTION OF THE INVENTION

Various preferred features and embodiments will be described below by way of non-limiting illustration.

Polymers are derived from the successive “linking” of monomers in a polymerization reaction. By linking, it means that the monomers become bonded together. The linking of monomers requires alteration of the chemical structures of the monomers for the purpose of freeing a bond the monomers can use to link by.

For example, the chemical structure of ethylene monomer is two CH2 units connected by a double bond;

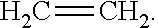

When ethylene monomers are polymerized, or linked, the double bond is opened and becomes free to bond with another ethylene monomer;

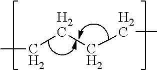

or otherwise represented as a repeating unit;

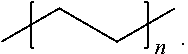

As can be seen, the repeating polyethylene unit is different from the starting ethylene monomer in that the double bond of the ethylene monomer has been opened. Although the polyethylene repeat unit is altered from the ethylene monomer from which it was derived, it is a common practice in the art of polymer plastics to refer to the repeating units of the polymer by the same name as the monomer. So, ethylene monomer refers both to CH2=CH2 and the polymerized repeat unit —[CH2-CH2]n-, where n is the number of repeat units in the polymer. Likewise, ethylene units or blocks of ethylene in the polymer means units or blocks derived from ethylene monomer. Similarly, styrene units or blocks of styrene in the polymer means units or blocks derived from styrene monomer, and so on for other types of monomers.

Those of ordinary skill in the art recognize that the polymerized monomer will be of altered chemical structure, but understand the relation between the repeat unit and the monomer from which the repeat unit was derived. Thus, as used in the description below and in the claims, monomer will refer both to a repeat unit of a polymer derived from the monomer, as well as the stand-alone monomer itself.

The technology provides an adhesive composition for use in an electrochemical cell, such as, for example, in a ceramic coated separator (CSS) in an electrochemical cell, such as, for example, a lithium-ion battery.

One aspect of the invention is directed to the adhesive composition. The adhesive composition includes a combination of a water based steric stabilizer polymer and polycarboxylic acid (PCA) polymer, such as a polyacrylic acid (PAA) polymer.

The water based steric stabilizer polymer will (1) contain at least 60 wt. % polyether, and (2) contain acid groups, and (3) a backbone having a weight average molecular weight (Mw) of 1000 or greater, such as 1000 to 50,000, or 1000 to 40,000, or even 1250 to 30,000, or 1500 to 4000 or 5000 as determined by gel permeation chromatography (GPC) based on polystyrene standards.

The water based steric stabilizer polymer includes reaction products of (i) a copolymer, and (ii) a mono-nucleophile (amine or alcohol) terminated polyether derived primarily from ethylene oxide.

The copolymer (i) of the water based steric stabilizer polymer is a copolymer of (1) maleic anhydride, itaconic anhydride, or a combination thereof, and (2) at least one non-acid containing monomer.

Non-acid containing monomers are monomers that do not contain any acid group, such as, for example, a carboxyl group, a sulphonic acid group, a phosphoric acid group, etc. Non-acid containing monomers can include, for example, styrene, ethylene, propylene, butadiene, isobutylene, octadecene, as well as substituted monomers such as vinyl chloride and acrylonitrile. Styrene maleic anhydride is a notable copolymer encompassed by the copolymer of (i), as are copolymers of itaconic anhydride and ethylene.

The molar ratio of non-acid containing monomer, for example, styrene, to anhydride monomer, for example, maleic anhydride or itaconic anhydride, in the copolymer can be, for example 1:1 to 3:1. The molar ratio of non-acid containing monomer, for example, styrene, to anhydride monomer, for example, maleic anhydride or itaconic anhydride, in the copolymer can also be, for example 2:1 or even 3:1.

The copolymer can have an Mn of about 1000 to 10,000 g/mol, or even from about 1500 to 9000 g/mol, or 2000 to 8000 g/mol, or even from about 2500 to about 7000 g/mol, or from about 3000 to about 6000 g/mol as measured by gel permeation chromatography (GPC) based on polystyrene standards. The copolymer is reacted with a polyether derived primarily from ethylene

oxide. The polyether copolymers may be random or block copolymers. In one embodiment, preferably the polyether chain is obtainable from at least 75 mol % ethylene oxide, or from about 75 to 100 mol % ethylene oxide, or 80 to 99 mol %, or 85 to 98 mol % or even 90 to 97 mol % ethylene oxide.

The mono-nucleophile on the polyether can be a mono-amine, an alcohol or a combination thereof

Polyetheramine may be prepared by reacting a mono-alcohol initiator with ethylene oxide only or with a mixture of ethylene oxide and another oxide, such as, for example, propylene oxide or butylene oxide, to form an alcohol-ended polymer chain, followed by conversion of the alcohol to an amine, to prepare n polyetheramine such as those described below. The polyether amine may be commercially available as the Surfonamine® amines from Huntsman Corporation. A specific example of Surfonamine® amines is L100 (ethylene oxide to propylene oxide ratio of 3 to 19) and L-207 (propylene oxide to ethylene oxide mix ratio of 10/33), L-200 (propylene oxide to ethylene oxide mix ratio of (4/41), and L-300 (propylene oxide to ethylene oxide mix ratio of 8/58). The figures in parentheses are approximate repeat units of propylene oxide, and ethylene oxide respectively.

An example mono-alcohol terminated polyether could be, for example, methoxy-polyethylene glycol.

The polyether of (ii) can have a Mn of 500 to 3500 g/mol as measured by gel permeation chromatography (GPC) based on polystyrene standards, or from about 600 to 3000 g/mol, or 700 to 2500 g/mol, or even about 800 to 2000 g/mol.

The mono-nucleophile terminated polyether can be reacted with about 30 to 100 mol % of the anhydride (i.e., maleic of itaconic anhydride), or even from about 35 to about 90 mol % anhydride, or 40 to 80 mol % anhydride, to form amide reaction products, imide reaction products, and combinations thereof.

The adhesive composition will also include a water compatible polycarboxylic acid (PCA) polymer, such as a polyacrylic acid (PAA) polymer. The term polycarboxylic acid or PCA polymer is used to encompass a variety of polymers having high percentages of polymerizable monomers therein with pendant carboxylic acid groups or anhydrides of polycarboxylic acid. These are described in more detail in U.S. Pat. Nos. 2,798,053; 3,915,921; 4,267,103; 5,288,814; and 5,349,030 hereby incorporated by reference. The term polycarboxylic acid or PCA is used to include various homopolymers, copolymers, and interpolymers, wherein at least 50 or 75 mole percent of the repeating units have pendant carboxylic acid groups or anhydrides of dicarboxylic acid groups. While acrylic acid is the most common primary monomer used to form PCA the term is not limited thereto but includes generally all α-β unsaturated monomers with carboxylic pendant groups or anhydrides of dicarboxylic acids as described in U.S. Pat. No. 5,349,030.

PCA polymers are prepared from monomers containing at least one activated >C═C< group and carboxyl group. Such polymers are homopolymers of an unsaturated, polymerizable carboxylic monomers such as acrylic acid, methacrylic acid, maleic acid, itaconic acid, maleic anhydride, and the like, and copolymers of polymerizable carboxylic monomers with acrylate esters, acrylamides, olefins, vinyl esters, vinyl ethers, or styrenics. These carboxyl containing polymers have molecular weights greater than about 500 to as high as several million g/mol, usually greater than about 10,000 to 900,000 g/mol or more.

Copolymers, for example, include copolymers of acrylic acid with small amounts of polyalkenyl polyether cross-linkers that are gel-like polymers, which, especially in the form of their salts, absorb large quantities of water or solvents with subsequent substantial increase in volume. Other useful PCA polymers are described in U.S. Pat. No. 3,940,351, directed to polymers of unsaturated carboxylic acid and at least one alkyl acrylic or methacrylic ester where the alkyl group contains 10 to 30 carbon atoms, and U.S. Pat. Nos. 5,034,486; 5,034,487; and 5,034,488; which are directed to maleic anhydride copolymers with vinyl ethers. Other types of such copolymers are described in U.S. Pat. No. 4,062,817 wherein the polymers described in U.S. Pat. No. 3,940,351 contain additionally another alkyl acrylic or methacrylic ester and the alkyl groups contain 1 to 8 carbon atoms. PCA polymers and copolymers such as those of acrylic acid and methacrylic acid also may be cross-linked with polyfunctional materials as divinyl benzene, unsaturated diesters and the like, as is disclosed in U.S. Pat. Nos. 2,340,110; 2,340,111; and 2,533,635. The disclosures of all of these U.S. Patents are hereby incorporated herein by reference.

The carboxylic monomers include olefinically-unsaturated carboxylic acids containing at least one activated carbon-to-carbon olefinic double bond, and at least one carboxyl group; that is, an acid or function readily converted to an acid containing an olefinic double bond which readily functions in polymerization because of its presence in the monomer molecule, either in the alpha-beta position with respect to a carboxyl group, —C═C—COOH; or as part of a terminal methylene grouping, CH2=C<. Olefinically-unsaturated acids of this class include such materials as the acrylic acids typified by the acrylic acid itself, alpha-cyano acrylic acid, beta methylacrylic acid (crotonic acid), alpha-phenyl acrylic acid, beta-acryloxy propionic acid, cinnamic acid, caffeic acid, p-chloro cinnamic acid, 1-carboxy-4-butadiene-1,3, citraconic acid, mesaconic acid, phenyl itaconic acid, glutaconic acid, aconitic acid, maleic acid, fumaric acid, and tricarboxy ethylene. As used herein, the term “carboxylic acid” includes the polycarboxylic acids and those acid anhydrides, such as maleic anhydride, wherein the anhydride group is formed by the elimination of one molecule of water from two carboxyl groups located on the same carboxylic acid molecule.

The preferred carboxylic monomers are the monoolefinic acrylic acids having the general structure:

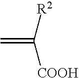

wherein R2 is a substituent selected from the class consisting of hydrogen, halogen, and the cyanogen (—C≡N) groups, monovalent alkyl radicals, monovalent aryl radicals, monovalent aralkyl radicals, monovalent alkaryl radicals and monovalent cycloaliphatic radicals. Of this class, acrylic and methacrylic acid are most preferred. Other useful carboxylic monomers are maleic acid and its anhydride.

The polymers include both homopolymers of carboxylic acids or anhydrides thereof, or the defined carboxylic acids copolymerized with one or more other vinylidene monomers containing at least one terminal >C═CH2 group. The other vinylidene monomers are present in an amount of less than 30 weight percent based upon the weight of the carboxylic acid or anhydride plus the vinylidene monomer(s). Such monomers include, for example, acrylate ester monomers including those acrylic acid ester monomers such as derivatives of an acrylic acid represented by the formula

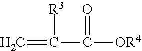

wherein R4 is an alkyl group having from 1 to 30 carbon atoms, preferably 1 to 20 carbon atoms and R3 is a substituent selected from the class consisting of hydrogen, halogen, and the cyanogen (—C≡N) groups, monovalent alkyl radicals, monovalent aryl radicals, monovalent aralkyl radicals, monovalent alkaryl radicals and monovalent cycloaliphatic radicals. Of this class, acrylic and methacrylic acid are most preferred. Other useful carboxylic monomers are maleic acid and its anhydride. Representative acrylates include methyl acrylate, ethyl acrylate, propyl acrylate, isopropyl acrylate, butyl acrylate, isobutyl acrylate, methyl methacrylate, methyl ethacrylate, ethyl methacrylate, octyl acrylate, heptyl acrylate, octyl methacrylate, isopropyl methacrylate, 2-ethylhexyl methacrylate, nonyl acrylate, hexyl acrylate, n-hexyl methacrylate, and the like. Higher alkyl acrylic esters are decyl acrylate, isodecyl methacrylate, lauryl acrylate, stearyl acrylate, behenyl acrylate and methyl acrylate. Mixtures of two or three or more long chain acrylic esters may be successfully polymerized with one of the carboxylic monomers. Other comonomers include olefins, including alpha olefins, vinyl ethers, vinyl esters, and mixtures thereof.

The polymers also may be cross-linked with any polyene, e.g. decadiene or trivinyl cyclohexane; acrylamides, such as methylene bis acrylamide; polyfunctional acrylates, such as trimethylol propane triacrylate; or polyfunctional vinylidene monomer containing at least 2 terminal CH2=C< groups, including for example, butadiene, isoprene, divinyl benzene, divinyl naphthlene, allyl acrylates and the like. Particularly useful cross-linking monomers for use in preparing the copolymers are polyalkenyl polyethers having more than one alkenyl ether grouping per molecule. The most useful possess alkenyl groups in which an olefinic double bond is present attached to a terminal methylene grouping, CH2=C<. They are made by the etherification of a polyhydric alcohol containing at least 2 carbon atoms and at least 2 hydroxyl groups. Compounds of this class may be produced by reacting an alkenyl halide, such as allyl chloride or allyl bromide, with a strongly alkaline aqueous solution of one or more polyhydric alcohols. The product may be a complex mixture of polyethers with varying numbers of ether groups. Analysis reveals the average number of ether groupings on each molecule. Efficiency of the polyether cross-linking agent increases with the number of potentially polymerizable groups on the molecule. It is preferred to utilize polyethers containing an average of two or more alkenyl ether groupings per molecule. Other cross-linking monomers include for example, diallyl esters, dimethallyl ethers, allyl or methallyl acrylates and acrylamides, tetraallyl tin, tetravinyl silane, polyalkenyl methanes, diacrylates, and dimethacrylates, divinyl compounds such as divinyl benzene, divinyl glycol, polyallyl phosphate, diallyloxy compounds and phosphite esters and the like. Typical agents are allyl pentaerythritol, allyl sucrose, trimethylolpropane triacrylate, 1,6-hexanediol diacrylate, trimethylolpropane diallyl ether, pentaerythritol triacrylate, tetramethylene dimethacrylate, ethylene diacrylate, ethylene dimethacrylate, triethylene glycol dimethacrylate, and the like. Allyl pentaerythritol, trimethylolpropane diallylether and allyl sucrose provide excellent polymers. When the cross-linking agent is present, the polymeric mixtures usually contain up to about 5% or less by weight of cross-linking monomer based on the total of carboxylic acid monomer, plus other monomers, if present, and more preferably about 0.01 to 3.0 weight percent.

Other vinylidene monomers may also be used, including the acrylic nitriles. The useful α,β-olefinically unsaturated nitriles are preferably the monoolefinically unsaturated nitriles having from 3 to 10 carbon atoms such as acrylonitrile, methacrylonitrile, and the like. Most preferred are acrylonitrile and (meth)acrylonitrile. The amounts used are, for example, for some polymers are from about 1 to 30 weight percent of the total monomers copolymerized. Acrylic amides containing from 3 to 35 carbon atoms including monoolefinically unsaturated amides also may be used. Representative amides include acrylamide, methacrylamide, N-t-butyl acrylamide, N-cyclohexyl acrylamide, higher alkyl amides, where the alkyl group on the nitrogen contains from 8 to 32 carbon atoms, acrylic amides including N-alkylol amides of alpha, beta-olefinically unsaturated carboxylic acids including those having from 4 to 10 carbon atoms such as N-methylol acrylamide, N-propanol acrylamide, N-methylol methacrylamide, N-methylol maleimide, N-methylol maleamic acid esters, N-methylol-p-vinyl benzamide, and the like. Still further useful materials are alpha-olefins containing from 2 to 18 carbon atoms, more preferably from 2 to 8 carbon atoms; dienes containing from 4 to 10 carbon atoms; vinyl esters and allyl esters such as vinyl acetate; vinyl aromatics such as styrene, methyl styrene, hydroxy styrene, and chlorostyrene; vinyl and allyl ethers and ketones such as vinyl methyl ether and methyl vinyl ketone; chloroacrylates; cyanoalkyl acrylates such as a-cyanomethyl acrylate, and the α-, β-, and γ-cyanopropyl acrylates; alkoxyacrylates such as methoxy ethyl acrylate; haloacrylates as chloroethyl acrylate; vinyl halides and vinyl chloride, vinylidene chloride and the like; divinyls, diacrylates and other polyfunctional monomers such as divinyl ether, diethylene glycol diacrylate, ethylene glycol dimethacrylate, ethylene-bisacrylamide, allylpentaerythritol, and the like; and bis (β-haloalkyl)alkenyl phosphonates such as bis (β-chloroethyl) vinyl phosphonate and the like as are known to those skilled in the art.

Numerous monomers have been taught for their potential use in synthesizing the PCA polymers. However, it is important to note that only specific combinations of monomers that result in the formation of water-compatible PCA polymers are considered. By carefully choosing the appropriate monomers, the desired degree of dissolution of the polymer (i.e., the polymers compatibility) in water can be achieved. Those of ordinary skill in the art will understand how to determine the monomer configuration to arrive at a PCA polymer having the desired water compatibility.

The PCA can further be neutralized with a neutralizing agent to prepare a partially neutralized (PPCA) polymer. It has been found that the degree of neutralization of the PCA polymer can impact the final properties of the adhesive composition. Accordingly, in one embodiment, prior to blending of the water based steric stabilizer polymer and PCA polymers, the PCA polymer can be partially neutralized (referred to as a PPCA polymer) from an initial pH of from about 2.0 up to about 8.0 or from about 2.0 up to about 6.5 or from about 2.0 up to about 4.0. For example, a polyacrylic acid (PAA) polymer may be neutralized in the foregoing manner to a partially neutralized polyacrylic acid (PPAA) polymer. In one embodiment the amount of neutralizer used can be from 25% to 50% of the theoretical value necessary to achieve a polymer solution of pH 7. In another embodiment, the amount of neutralization is from 10% to 75% of the acid content of the polymer. In a still further embodiment, the pH of the polymer solution is from 4 to 8. Neutralization can be carried out with any convenient neutralizing agent or compound such as ammonium hydroxide, sodium hydroxide, lithium hydroxide, other alkali hydroxides, borates, phosphates, pyrophosphates or polyphosphates; ammonia, an amino acid, such as arginine; AMP-95 (2-Amino-2-Methyl-1-Propanol) a product of Angus Chemical, cocamine, oleamine, diisopropanolamine, diisopropylamine, dodecylamine, PEG-15 cocoamine, morpholine, tetrakis (hydroxypropyl)ethylenediamine, triamylamine, triethanolamine, triethylamine, or tromethamine (2-Amino 2-Hydroxymethyl-1,3-propanediol). In some embodiments, neutralizing agents include NaOH, tetrakis (hydroxypropyl)ethylenediamine, triethanolamine, and tromethamine. As used herein, PCA encompasses both non-neutralized and partially neutralized polyacrylic acid (PPCA).

The PCA (including PPCA) can have a number average molecular weight (Mn) of from about 2000 to about 900,000, or from about 3000 to about 800,000, or from about 4000 to about 700,000, or even from about 5000 to about 600,000 as measured by gel permeation chromatography (GPC) based on polystyrene standards.

The weight ratio of the water based steric stabilizer polymer:PCA (including PPCA) can vary between 9:1 to 1:9. The weight ratios can also include 8:1 to 1:8, 7:1 to 1:7, 6:1 to 1:6, 5:1 to 1:5, 4:1 to 1:4, 3:1 to 1:3, 2:1 to 1:2, and 1:1. Additionally, the weight ratio of water based steric stabilizer polymer:PCA (including PPCA) can be at intermediate ratios such as 7:2 to 2:7, 3:7 to 7:3, 5:3 to 3:5, 4:3 to 3:4, 5:4 to 4:5, 6:5 to 5:6, and 8:7 to 7:8.

The adhesive composition may be made into a slurry by addition of a solvent. With respect to a separator for electrochemical cells, the adhesive slurry composition containing the combination of water based steric stabilizer polymer and PCA, along with ceramic particles and optional other additives may be used to coat a separator material for an electrochemical cell.

To prepare such a slurry, the ceramic particles can be mixed with the combination of water based steric stabilizer and PCA along with a solvent (e.g., water, ethanol, etc.) and any of the other desired additives. Other additives that may be used in the mixture can include, for example, thickeners, wetting agents and defoamers, among others known to those of skill in the art. As used herein, adhesive slurry composition and adhesive composition may be used interchangeably.

The ceramic particles are not particularly limited, and conventionally-known materials may be used. Examples of the ceramic particles include silica (SiO2), alumina (Al2O3), alumina silicate (SiO2/Al2O3), zirconia (ZrO2), ceria (CeO2), and titania (TiO2). These ceramic particles may be used alone or in combination of two or more.

In one embodiment, the at least one ceramic particle may be at least one of alumina and/or alumina oxide hydroxide. In one embodiment, the at least one ceramic particle is in powder form. The at least one ceramic particle may have a particle size volume distribution wherein the Dv90 value is in a range of from about less than 1000 nm as measured by dynamic light scattering measurements using a Malvern Zetasizer Ultra laser, or less than 900 nm, or less than 800 nm, or between 50 and 1000 nm, or between 100 and 900 nm, or between 200 and 800 nm, or between 300 and 600 nm. Dv90 signifies the point in the size distribution, up to and including which, 90% of the total volume of material in the sample is contained. For example, if the Dv90 is 1000 nm, this means that 90% of the sample has a size of 1000 nm or smaller.

The at least one ceramic particle can be present in the adhesive slurry composition in a range of from about 10 to about 60 wt. %, or from about 15 to about 55 wt. %, or from about 20 to about 50 wt. %, or from about 25 to about 45 wt. %.

The combination of water based steric stabilizer and PCA can be present in the adhesive slurry composition in a range of from about 0.25 to about 10 wt. %, or from about 0.5 to about 8 wt. %, or from 0.75 to about 4 wt. %. In some embodiments, the combination of water based steric stabilizer and PCA can be present at from about 0.1 to about 3 wt. %, or from about 0.25 to about 2 wt. %, or from about 0.5 to about 1.5 wt. %.

The adhesive composition can also be employed to suspend other particulates beside ceramic particles. Non-ceramic particulate materials can include those used for anode/cathode applications, for example. The adhesive composition may be employed for battery coatings, such as those related to cathode/anode primers, cathode binders and/or anode binders, as well as an adhesive for ceramic coated separators.

Another aspect of the present invention is directed to a CCS for an electrochemical cell, for example but without limitation, a lithium-ion battery. The CCS must allow permeability of lithium ions, i.e., conducts lithium ions, but be a nonconductor for electrons.

Polymers can be used as the base layer for the CCS. In one embodiment, the polymers can be, for example, polyesters, preferably polyethylene terephthalate; polyolefin, preferably polyethylene, polypropylene; polyacrylonitrile; polyvinylidene fluoride; polyvinylidene-hexafluoropropylene; polyetherimide; polyimide, polyamide, polyethers; polyetherketone, or mixtures thereof.

The CCS can include a separator and the above-described adhesive composition, wherein the adhesive composition is in contact with at least a portion of the separator. In one embodiment, the CCS comprises a separator that has been coated with the above-described adhesive composition on at least one side of the separator. In another embodiment, the CCS comprises a separator that has been coated with the above-described adhesive composition on two sides of the separator. In any of the above-described embodiments of the CCS, the above-described adhesive composition may be coated on the separator such that the coating is uniformly distributed on at least one side of the separator.

In one embodiment, the separator can be pre-treated to improve the wetting of the ceramic coating composition onto the separator. Non-limiting examples of methods of pre-treating the separator include subjecting the separator to at least one of corona treatment, atmospheric plasma treatment, flame plasma treatment, chemical plasma treatment, ozone treatment, treatment with other polymers or copolymers, and treatment with polydopamine.

In another embodiment, the separator has not been pre-treated.

The present disclosure is also directed to a method of making a CCS for an electrochemical cell, wherein the electrochemical cell may be, for example but without limitation, a lithium-ion battery. In one embodiment, the method of making the CCS as disclosed herein includes: (a) applying the adhesive slurry composition as described herein to at least one side of a separator to form a coated separator comprising a slurry layer on the separator, and (b) drying the slurry layer on the coated separator to form a ceramic coating on the separator (i.e., the “CCS”).

In another embodiment, the slurry layer on the separator is further conditioned at a temperature of up to about 100° C. for up to about 24 hours, or up to about 12 hours, or up to about 6 hours, or up to about 3 hours, or up to about 2 hours, or up to about 1 hour. In yet another embodiment, the step of drying the slurry layer for any of the aforementioned embodiments comprises conditioning the slurry layer at a temperature in a range of from about 60° C. to about 80° C. for about 30 minutes, or for about 20 minutes, or for about 10 minutes, or for about 5 minutes.

The methods for applying the adhesive slurry composition to the separator may include any conventional coating manner as would be known to a person skilled in the art such as, for example but without limitation, dip coating, gravure coating, spray coating, electrospin and/or electrospun coating, meyer rod dip coating, slot die and/or extrusion coating, sputtering, vapor deposition, sputtering chemical vapor deposition, and/or combinations thereof. The adhesive slurry composition can be applied to one or more sides of the separator. In one embodiment, the adhesive slurry composition is coated onto the separator two or more times until the desired thickness is achieved.

The present disclosure is also directed to the use of the above-described CCS in an electrochemical cell such as, for example but without limitation, fuel cells, lead acid batteries, and/or capacitors.

Likewise, the present disclosure is directed to a battery comprising the presently disclosed CCS. In one embodiment, the battery may be a lithium-ion battery.

The present disclosure is also directed to an electrochemical cell comprising the presently disclosed CCS, at least one cathode, and at least one anode. The electrochemical cell may further comprise at least one electrolyte. Additionally, the cathodes and anodes may be any suitable cathode and/or anode as would be known to a person of ordinary skill in the field. The electrolyte may be in the form of a gel and/or liquid.

The present invention also provides a method of improving battery cell cycling that encompasses preparing a battery separator coated with an adhesive slurry containing a water based steric stabilizer polymer, a PCA polymer and a ceramic particle, and applying the battery separator to the battery cell, and cycling the battery.

The amount of each chemical component described is presented exclusive of any solvent or diluent, which may be customarily present in the commercial material, that is, on an active chemical basis, unless otherwise indicated. However, unless otherwise indicated, each chemical or composition referred to herein should be interpreted as being a commercial grade material which may contain the isomers, by-products, derivatives, and other such materials which are normally understood to be present in the commercial grade.

It is known that some of the materials described above may interact in the final formulation, so that the components of the final formulation may be different from those that are initially added. For instance, metal ions can migrate to other acidic or anionic sites of other molecules. The products formed thereby, including the products formed upon employing the composition of the present invention in its intended use, may not be susceptible of easy description. Nevertheless, all such modifications and reaction products are included within the scope of the present invention; the present invention encompasses the composition prepared by admixing the components described above.

### EXAMPLES

Polycarboxylic acid polymer and Water based Steric Stabilizer Polymer

A partially sodium neutralized homopolymer of polyacrylic acid with an approximate molecular weight of 345,000 Daltons was used as the polycarboxylic acid polymer. The polyacrylic acid copolymer is herein denoted as PCA-1. A water based steric stabilizer polymer that was the reaction product of Xiran® 2000P (a 3000 MW styrene-maleic anhydride polymer with a 2:1 ratio of styrene to maleic anhydride) and Surfonamine® L100 (a 1000 molecular weight mono-amine functional polyether containing 19 ethylene oxide units and 3 propylene oxide units). After reaction completion the water based steric stabilizer was dissolved in de-mineralized water at 40% solids. The water based steric stabilizer is herein denoted as WBSS-1.

### Preparation of Ceramic Separator Slurries

A series of ceramic separator slurries were prepared by dissolving PCA-1, WBSS-1, or mixtures thereof, and allowing them to fully equilibrate for 24 hours. A ball mill was used to disperse ceramic powder SAO-030E-N from Shangdong Sinocera Functional Material Company (alpha alumina having a D50 value of 0.4-0.6 microns and BET surface area of 7-9 m2/gram) into an aqueous slurry according having an alumina concentration of 35 weight percent. The weight percent of PCA-1 plus WBSS-1 was held constant at a concentration of 35 weight percent. The ratios of WBSS to PCA-1 in the ceramic separator slurries is shown in table 1. The particle size of the alumina slurries was characterized using a Zetasizer® light scattering instrument from Malvern and the Dv90 particle size is shown in table 1 in nanometers.

TABLE 1
Composition of Ceramic Separator Slurries

| | Ratio of WBSS to | |
|---|---|---|
| Ceramic Separator Slurry | PCA-1 | D90 (Nanometers) |
| Comparative Slurry 1 | PCA-1 only | 674 |
| Comparative Slurry 2 | WBSS only | 461 |
| Inventive Slurry 1 | 7:3 | 419 |
| Inventive Slurry 2 | 9:1 | 423 |

### Preparation of Ceramic Coated Separator

Ceramic coated separators were prepared by casting the ceramic separator slurries in order to achieve a 1-3 micron thick ceramic layer onto a plasma treated trilayer polypropylene/polyethylene/polypropylene separator (Celgard® 2325). The coated separators were dried under vacuum at 70° C. for two hours.

A carbon coated Lithium Iron Phosphate (LFP) cathode (90% LFP, 5% Super P® Imerys conductive carbon, and 5% polyvinylidene fluoride binder) was prepared using N-methyl pyrrolidone solvent. The LFP coating was applied to a conductive carbon coated aluminum current collector using a doctor blade. A Lithium hexafluorophsphate solution in ethylene carbonate, dimethyl carbonate and diethyl carbonate (1:1:1 volume ratio) was used as the electrolyte to test battery performance.

### Testing

The adhesion of the ceramic separator was measured via the 180° peel test method. (Equipment info: MTS Criterion Model 42 mechanical tester equipped with a 250N load cell and pneumatic grips). The test was conducted at a constant speed of 100 mm/min in tensile direction to determine the peel strength required to de-bond Al₂O₃ coating on the base membrane. Peel strength was calculated using the equation “Peel Strength=“average load (N)”/“Specimen width (mm).”

| Ceramic Separator | Ratio of WBSS to | |
|---|---|---|
| Coating | PCA-1 | Peel Strength (N/m) |
| Comparative Coating 1 | PCA-1 only | 106.1 |
| Comparative Coating 2 | WBSS only | 151.4 |
| Inventive Coating 1 | 7:3 | 137.7 |
| Inventive Coating 2 | 9:1 | 135.9 |

### Contact Angle

Deionized water was used for water contact angle measurements, which were conducted with Contact Angle Data Physics, OCA 15EC package 2.

### Electrolyte Uptake

Electrolyte uptake testing was conducted to screen the viability and compatibility of the polymer to be used for such application. This can provide visibility on the solubility of the polymer when it was soaked in an electrolyte for an extended period. This value was obtained by calculating the weight difference of the polymer (film)/CCS measured before and after it was being soaked in a mixture of carbonate solvents (EC/DMC/DEC=1:1:1 (v/v/v)) (which are typically used in electrolyte) at 25° C. for 5 hours, i.e., equation Electrolyte uptake %=(“Final weight“−“Initial weight”)/“Initial weight”×100%.

| Ceramic Separator | Ratio of WBSS to | Electrolyte | Contact Angle, |
|---|---|---|---|
| Coating | PCA-1 | Uptake (%) | Water (°) |
| Comparative | PCA-1 only | 121.0 | 0.0 |
| Coating 1 | | | |
| Comparative | WBSS only | 126.0 | 82.3 |
| Coating 2 | | | |
| Inventive Coating 1 | 7:3 | 136.0 | 73.6 |
| Inventive Coating 2 | 9:1 | 134.0 | 76.2 |

### Cell/Battery Cycling Data

The battery cells were constructed as follows. The cathode was prepared by mixing 90% of LFP powder, 5% of Super P and 5% of PVDF using Thinky mixer ARE-310, then coated on a carbon-coated aluminum current collector via a doctor blade. The wet cathode was then dried at 120° C. for 12 hours under vacuum and punched into 12 mm diameter discs. The active mass loading was approximately 5 mg/cm2, 20 μm thick. Electrochemical performance was evaluated in 2032-coin cell configuration. Coin cells were assembled in an argon filled glovebox with <0.1 ppm of moisture and oxygen. 50 μL of electrolyte was used in each cell. These cells were first aged for 12 hours and precycled at 0.2 C for 2 cycles (2.5 V to 4.2 V). To evaluate the cycling performance, these cells were cycled at a constant charge/discharge of 0.5 C from 2.5 V to 4.2 V for 250 cycles. Rate performances were conducted at current rates of 0.1 C, 0.5 C, 1 C, 2 C, 5 C and back at 0.1 C.

Cell Cycling Results—Electrochemical Performances of LFP/CCS/Li Cells. I.e., Galvanostatic Cycling Performance at a Rate of 0.5 C

| | Comparative | Comparative | Inventive |
|---|---|---|---|
| | Coating 1 | Coating 2 | Coating 1 |
| Cycle | (mAh/g) | (mAh/g) | (mAh/g) |
| 25 | 156.2 | 155.6 | 158.8 |
| 50 | 156.1 | 155.5 | 158.7 |
| 75 | 157.3 | 155.2 | 158.7 |
| 100 | 157.2 | 154.3 | 158.5 |
| 125 | 157.1 | 153.9 | 158.3 |
| 150 | 155.9 | 152.9 | 157.9 |
| 175 | 153.9 | 152.1 | 157.7 |
| 200 | 152.4 | 151.3 | 157.5 |
| 225 | 151.4 | 150.1 | 157.4 |
| 250 | 150.3 | 148.7 | 157.2 |

Charge Rate Results—Rate performance at 0.1 C, 0.5 C, 1 C, 2 C and 0.1 C

| | | Comparative | Comparative | Inventive |
|---|---|---|---|---|
| | | Coating 1 | Coating 2 | Coating 1 |
| Cycle | C rate | (mAh/g) | (mAh/g) | (mAh/g) |
| 5 | 0.1 C | 159.0 | 160.0 | 160.0 |
| 10 | 0.5 C | 153.9 | 153.1 | 155.2 |
| 15 | 1 C | 148.0 | 146.7 | 150.1 |
| 20 | 2 C | 139.3 | 138.9 | 142.5 |
| 25 | 5 C | 119.7 | 121.3 | 125.6 |
| 30 | 0.1 C | 149.6 | 153.9 | 157.2 |

Each of the documents referred to above is incorporated herein by reference. The mention of any document is not an admission that such document qualifies as prior art or constitutes the general knowledge of the skilled person in any jurisdiction. Except in the Examples, or where otherwise explicitly indicated, all numerical quantities in this description specifying amounts of materials, reaction conditions, molecular weights, number of carbon atoms, and the like, are to be understood as modified by the word “about.” It is to be understood that the upper and lower amount, range, and ratio limits set forth herein may be independently combined. Similarly, the ranges and amounts for each element of the invention can be used together with ranges or amounts for any of the other elements. As used herein, the expression “consisting essentially of” permits the inclusion of substances that do not materially affect the basic and novel characteristics of the composition under consideration.
Clause 1 A method of improving electrochemical cell cycling comprising (a) preparing a separator comprising coating a polymeric film with (i) an adhesive composition comprising a combination of a water based steric stabilizer polymer containing at least 60 wt. % polyether and containing acid groups and a polycarboxylic acid (PCA) polymer, and (ii) ceramic particles, (b) installing the separator in the electrochemical cell, and (c) cycling the electrochemical cell.
Clause 2 The method of Clause 1 wherein the electrochemical cell comprises a lithium-ion battery.
Clause 3 The method of Clause 1, wherein the ratio of the water based steric stabilizer polymer to PCA is between 1:9 to 9:1 by weight.
Clause 4 The method of Clause 1, wherein the weight ratio of the water based steric stabilizer polymer to PCA is between 8:1 to 1:8.
Clause 5 The method of Clause 1, wherein the weight ratio of the water based steric stabilizer polymer to PCA is between 7:1 to 1:7.
Clause 6 The method of Clause 1, wherein the weight ratio of the water based steric stabilizer polymer to PCA is between 6:1 to 1:6.
Clause 7 The method of Clause 1, wherein the weight ratio of the water based steric stabilizer polymer to PCA is between 5:1 to 1:5.
Clause 8 The method of Clause 1, wherein the weight ratio of the water based steric stabilizer polymer to PCA is between 4:1 to 1:4.
Clause 9 The method of Clause 1, wherein the weight ratio of the water based steric stabilizer polymer to PCA is between 3:1 to 1:3.
Clause 10 The method of Clause 1, wherein the weight ratio of the water based steric stabilizer polymer to PCA is between 2:1 to 1:2.
Clause 11 The method of Clause 1, wherein the weight ratio of the water based steric stabilizer polymer to PCA is 1:1.
Clause 12 The method of Clause 1, wherein the weight ratio of the water based steric stabilizer polymer to PCA is between 7:2 to 2:7.
Clause 13 The method of Clause 1, wherein the weight ratio of the water based steric stabilizer polymer to PCA is between 3:7 to 7:3.
Clause 14 The method of Clause 1, wherein the weight ratio of the water based steric stabilizer polymer to PCA is between 5:3 to 3:5.
Clause 15 The method of Clause 1, wherein the weight ratio of the water based steric stabilizer polymer to PCA is between 4:3 to 3:4.
Clause 16 The method of Clause 1, wherein the weight ratio of the water based steric stabilizer polymer to PCA is between 5:4 to 4:5.
Clause 17 The method of Clause 1, wherein the weight ratio of the water based steric stabilizer polymer to PCA is between 6:5 to 5:6.
Clause 18 The method of Clause 1, wherein the weight ratio of the water based steric stabilizer polymer to PCA is between 8:7 to 7:8.
Clause 19 The method of Clause 1 to Clause 18, wherein the water based steric stabilizer dispersant has a number average molecular weight of 3000 g/mol or greater as measured by gel permeation chromatography (GPC) based on polystyrene standards.
Clause 20 The method of Clause 1 to Clause 19, wherein the water based steric stabilizer polymer comprises a reaction product of (i) a copolymer of (1) maleic anhydride, itaconic anhydride, or a combination thereof, and (2) at least one non-acid containing monomer, and (ii) a mono-nucleophile (amine or alcohol) terminated polyether derived primarily from ethylene oxide.
Clause 21 The method of Clause 1 to Clause 20, wherein the water based steric stabilizer polymer comprises a reaction product of (i) a copolymer of (1) maleic anhydride, and (2) at least one non-acid containing monomer, and (ii) a mono-nucleophile (amine or alcohol) terminated polyether derived primarily from ethylene oxide.
Clause 22 The method of Clause 1 to Clause 21, wherein the water based steric stabilizer polymer comprises a reaction product of (i) a copolymer of (1) itaconic anhydride, and (2) at least one non-acid containing monomer, and (ii) a mono-nucleophile (amine or alcohol) terminated polyether derived primarily from ethylene oxide.
Clause 23 The method of Clause 1 to Clause 22, wherein the at least one non-acid containing monomer of (2) comprises styrene.
Clause 24 The method of any of Clause 1 to Clause 23, wherein the at least one non-acid containing monomer of (2) comprises at least one of ethylene, propylene, butadiene, isobutylene, octadecene, vinyl chloride and acrylonitrile.
Clause 25 The method of Clause 1 to Clause 24, wherein the weight ratio of non-acid containing monomer (2) to anhydride (1) in copolymer (i) is from 1:1 to 3:1.
Clause 26 The method of Clause 1 to Clause 25, wherein the weight ratio of non-acid containing monomer (2) to anhydride (1) in copolymer (i) is 2:1.
Clause 27 The method of Clause 1 to Clause 26, wherein the mono-nucleophile comprises a mono-amine.
Clause 28 The method of Clause 1 to Clause 27, wherein the mono-nucleophile comprises a mono-alcohol.
Clause 29 The method of Clause 1 to Clause 28, wherein the polyether of the mono-nucleophile terminated polyether of (ii) comprises greater than 75 mol % of repeat units derived from ethylene oxide.
Clause 30 The method of Clause 1 to Clause 29, wherein the polyether of the mono-nucleophile terminated polyether of (ii) comprises greater than 80 mol % of repeat units derived from ethylene oxide.
Clause 31 The method of Clause 1 to Clause 30, wherein the polyether of the mono-nucleophile terminated polyether of (ii) comprises greater than 85 mol % of repeat units derived from ethylene oxide.
Clause 32 The method of Clause 1 to Clause 31, wherein the polyether of the mono-nucleophile terminated polyether of (ii) comprises greater than 90 mol % of repeat units derived from ethylene oxide.
Clause 33 The method of Clause 1 to Clause 32, wherein the polyether of the mono-nucleophile terminated polyether of (ii) comprises greater than 95 mol % of repeat units derived from ethylene oxide.
Clause 34 The method of Clause 1 to Clause 33, wherein from 30 to 100 mol % of the anhydride of (1) in copolymer (i) are reacted with the mono-nucleophile terminated polyether of (ii).
Clause 35 The method of Clause 1 to Clause 34, wherein from 35 to 90 mol % of the anhydride of (1) in copolymer (i) are reacted with the mono-nucleophile terminated polyether of (ii).
Clause 36 The method of Clause 1 to Clause 35, wherein from 40 to 80 mol % of the anhydride of (1) in copolymer (i) are reacted with the mono-nucleophile terminated polyether of (ii).
Clause 37 The method of Clause 1 to Clause 36 wherein the polycarboxylic acid polymer comprises a polyacrylic acid (PCA) polymer.
Clause 38 The method of Clause 1 to Clause 37, wherein the PCA comprises a polymer of monoolefinic acrylic acid.
Clause 39 The method of Clause 1 to Clause 38, wherein the PCA polymer comprises partially neutralized polycarboxylic acid (PPCA).
Clause 40 The method of Clause 1 to Clause 39, wherein the PCA polymer comprises partially neutralized polycarboxylic acid (PPCA).
Clause 41 The method of Clause 1 to Clause 40, wherein the PCA has a number average molecular weight Mn of between 2000 and 900,000 g/mol as measured by gel permeation chromatography (GPC) based on polystyrene standards.
Clause 42 The method of any of Clause 1 to Clause 41, further comprising ceramic particles.
Clause 43 The method of Clause 42, wherein the ceramic particles comprise a-alumina.
Clause 44 The method of either of Clause 42 or Clause 43, wherein the ceramic particles have a Dv90 particle size of less than 1000 nm.
Clause 45 The method of any of Clause 42 to Clause 44, wherein the ceramic particles are present between 50 to 99 wt. %.
Clause 46 The method of any of Clause 1 to Clause 45, wherein the combination of the water based steric stabilizer polymer and PCA polymer is present at from 0.25 to 10 wt. %.
Clause 47 The method of any of Clause 1 to Clause 46, further comprising a 5 wetting agent.
Clause 48 The method of any of Clause 1 to Clause 47, further comprising a thickener.
Clause 49 The method of any of Clause 1 to Clause 48, further comprising a solvent.

What is claimed is:

1. A method of improving electrochemical cell cycling comprising (a) preparing a separator comprising coating a polymeric film with (i) an adhesive composition comprising a combination of a water based steric stabilizer polymer containing at least 60 wt. % polyether and containing acid groups and a polycarboxylic acid (PCA) polymer, and (ii) ceramic particles, (b) installing the separator in the electrochemical cell, and (c) cycling the electrochemical cell.
